(19) United States
(12) Patent Application Publication
(10) Pub. No.: US 2021/0102340 A1
(43) Pub. Date: Apr. 8, 2021

(54) PRODUCTION OF HIGHLY STRETCHABLE PAPER HAVING SATISFACTORY SURFACE PROPERTIES

(71) Applicant: BILLERUDKORSNÄS AB, Solna (SE)

(72) Inventors: Nils Nordling, Kalix (SE); Fredrik Nordsröm, Karlstad (SE)

(21) Appl. No.: 16/500,320

(22) PCT Filed: Apr. 5, 2018
(86) PCT No.: PCT/EP2018/058720

§ 371 Date: Oct. 2, 2019

(30) Foreign Application Priority Data
Apr. 6, 2017 (EP) 17165160.7

(51) Int. Cl. D21F 9/02; D21H 11/04; D21D 1/20; D21G 1/00; B41F 17/00

(52) U.S. Cl. CPC D21F 9/02; D21H 11/04; B41F 17/003; D21G 1/006; D21G 1/004; D21D 1/20

(57) ABSTRACT

There is provided a method of producing uncoated paper having a grammage according to ISO 536 of 50-250 g/m², a Gurley value according to ISO 5636-5 of above 15 s and a stretchability according to ISO 1924-3 in the machine direction of at least 9%, said method comprising the steps of: 5 a) providing a pulp, preferably sulphate pulp; b) subjecting the pulp to high consistency (HC) refining; c) subjecting the pulp from step b) to low consistency (LC) refining; d) diluting the pulp from step c) and adding the diluted pulp to a forming wire to obtain a paper web having a dry content of 15-25%, such as 17-23%;10 e) pressing the paper web from step d) to a dry content of 30-50%, such as 36-46%; f) drying the paper web from step e); g) compacting the paper web from step f) in a Clupak unit at a moisture content of 20-50%, such as 30-49%, such as 35-49%;15 h) drying the paper web from step g); and i) calendering the paper web from step h) in a soft nip calender or a long nip calender at a moisture content of 4-20%, such as 5-12%, such as 5-10%.

### TECHNICAL FIELD

The invention relates to the production of a highly stretchable paper having satisfactory surface properties.

### BACKGROUND

BillerudKorsnäs AB (Sweden) has marketed a highly stretchable paper under the name FibreForm® since 2009. The stretchability of FibreForm® allows it to replace plastics in many applications. FibreForm has been produced on paper machine comprising an Expanda unit that compacts/creps the paper in the machine direction to improve the stretchability.

### SUMMARY

The object of the present disclosure is to provide a method of producing a highly stretchable uncoated paper that is not a typical porous sack paper on a paper machine comprising a Clupak unit without compromising with printability.

There is thus provided a method of producing uncoated paper having a grammage according to ISO 536 of 50-250 g/m², a Gurley value according to ISO 5636-5 of above 15 s and a stretchability according to ISO 1924-3 in the machine direction of at least ₉%, said method comprising the steps of:

a) providing a pulp, preferably sulphate pulp;

b) subjecting the pulp to high consistency (HC) refining;

c) subjecting the pulp from step b) to low consistency (LC) refining;

d) diluting the pulp from step c) and adding the diluted pulp to a forming wire to obtain a paper web having a dry content of 15-25%, such as 17-23%;

e) pressing the paper web from step d) to a dry content of 30-50%, such as 36-46%;

f) drying the paper web from step e);

g) compacting the paper web from step f) in a Clupak unit at a moisture content of 20-50%, such as 30-49%, such as 35-49%;

h) drying the paper web from step g); and

i) calendering the paper web from step h) in a soft nip calender or a long nip calender at a moisture content of ₄-20%, such as 5-12%, such as 5-10%.

### BRIEF DESCRIPTION OF THE DRAWINGS

FIG. 1 is a schematic illustration of a Clupak unit.

### DETAILED DESCRIPTION

The present disclosure relates to a method of producing uncoated paper. Subsequent to the method of the present disclosure, the paper may be coated, e.g. to improve printing properties and/or to obtain barrier properties.

The paper obtained by the method is characterized by its stretchability, which is at least ₉% in the machine direction (MD). Preferably, the stretchability in MD is even higher than ₉%, such as at least 10% or at least 11%. The stretchability enables formation of three-dimensional (double curvature) shapes in the paper, e.g. by press forming, vacuum forming or deep drawing. The formability of the paper in such processes is further improved if the stretchability is relatively high also in the cross direction (CD). Preferably, the stretchability in CD is at least ₇%, such as at least ₉%. An upper limit for the stretchability in MD may for example be 20% or 25%. An upper limit for the stretchability in CD may for example be 15%. The stretchability (in both MD and CD) is determined according to the standard ISO 1924-3.

In contrast to many sack papers, which may be highly stretchable, the paper of the present disclosure is not particularly porous. Instead, relatively low porosity may be preferred in the applications intended for the paper of the present disclosure. For example, glue and some coatings have a lower tendency to bleed through a paper of low porosity. Further, some printing properties are improved when the porosity is reduced.

The air resistance according to Gurley, i.e. the Gurley porosity, is a measurement of the time (s) taken for 100 ml of air to pass through a specified area of a paper sheet. Short time means highly porous paper. The Gurley porosity of the paper of the present disclosure is above 15 s. The Gurley porosity is preferably at least 20 s and more preferably 25 s, such as at least 35 s. An upper limit may for example be 120 s or 150 s. The Gurley porosity (herein also referred to as the “Gurley value”) is determined according to ISO 5636-5.

The grammage of the paper of the present disclosure is 50-250 g/m². If a stretchable material having a grammage above 250 g/m² is desired, a laminate can be produced from a plurality of paper layers each having a grammage in the range of 50-250 g/m₂. Below 50 g/m² the strength and rigidity is typically insufficient. The grammage is preferably 60-220 g/m² and more preferably 80-200 g/m², such as 80-160 g/m², such as 80-130 g/m². The standard ISO 536 is used to determine the grammage. The Bendtsen roughness is typically lower when the grammage is lower.

The density of the paper is typically between 700 and 1000 kg/m³. To obtain a density below 850 kg/m³, a long nip calender (further discussed below) can be selected. Preferred density ranges are 700-800 kg/m³ and 710-780 kg/m³.

For aesthetic and printing purposed, the paper of the present disclosure is preferably white. For example, its brightness according to ISO 2470 may be at least 80%, such as at least 82%. However, the paper may also be unbleached (“brown”).

The method of the present disclosure comprises the step of:

a) providing a pulp.

The pulp is preferably a sulphate pulp (sometimes referred to as a “Kraft pulp”), which provides high tensile strength. For the same reason, the starting material used for preparing the pulp preferably comprises softwood (which has long fibers and forms a strong paper). Accordingly, the pulp may comprise at least 50% softwood pulp, preferably at least 75% softwood pulp and more preferably at least 90% softwood pulp. The percentages are based of the dry weight of the pulp.

The tensile strength is the maximum force that a paper will withstand before breaking. In the standard test ISO 1924-3, a stripe having a width of 15 mm and a length of 100 mm is used with a constant rate of elongation. Tensile energy absorption (TEA) is sometimes considered to be the paper property that best represents the relevant strength of a paper. The tensile strength is one parameter in the measurement of the TEA and another parameter is stretchability. The tensile strength, the stretchability and the TEA value are obtained in the same test. The TEA index is the TEA value divided by the grammage. In the same manner, the tensile index is obtained by dividing the tensile strength by the grammage.

A dry strength agent, such as starch, may be added to improve tensile strength. The amount of starch may for example be 1-15 kg per ton paper, preferably 1-10 or 2-8 kg per ton paper. The starch is preferably cationic starch.

In the context of the present disclosure, “per ton paper” refers to per ton of dried paper from the paper making process. Such dried paper normally has a dry matter content (w/w) of 90-95%.

The TEA index of the paper obtained by the method of the present disclosure may for example be at least 3.5 J/g in the MD (e.g. 3.5-7.5 J/g) and/or at least 2.9 J/g (e.g. 2.9-3.9 J/g) in the CD. In one embodiment, the TEA index is above 4.5 J/g (e.g. 4.6-7.5 J/g) in MD.

One or more sizing agent may also be added to the pulp. Examples of sizing agents are AKD, ASA and rosin size. When rosin size is added, it is preferred to also add alum. Rosin size and alum is preferably added in a weight ratio between 1:1 and 1:2. Rosin size can for example be added in an amount of 0.5-4 kg per ton paper, preferably 0.7-2.5 kg per ton paper.

When the paper is white, the pulp is bleached.

The method further comprises the step of:

b) subjecting the pulp to high consistency (HC) refining.

The consistency of the pulp subjected to HC refining is typically 25-42% or 25-40%, such as 30-40%, preferably 33-40%. The HC refining is typically carried out to the extent that the pulp obtains a Schopper-Riegler (SR) number of 13-19, such as 13-18. The SR number is measured according to ISO 5267-1. To reach the desired SR number, the energy supply in the HC refining may be at least 100 kWh per ton paper, such as 150-220 kWh per ton paper.

The method further comprises the step of:

c) subjecting the pulp from step b) to low consistency (LC) refining;

The consistency of the pulp subjected to LC refining is typically 2-6%, preferably 3-5%. The LC refining is typically carried out to the extent that the pulp obtains a Schopper-Riegler (SR) number of 18-40, preferably 19-35, such as 23-35. To reach the desired SR number, the energy supply in the LC refining may be 20-200 kWh per ton paper, such as 30-150 kWh per ton paper, such as 40-120 kWh per ton paper.

As well known to the skilled person, LC refining increases the SR number.

The HC refining and the LC refining increase the stretchability in both MD and CD.

In one embodiment, the method comprises a step of adding broke pulp, preferably to the pulp from step b) or c). The broke pulp is preferably obtained from the same method.

The method further comprises the step of:

d) diluting the pulp from step c) and adding the diluted pulp to a forming wire to obtain a paper web having a dry content of 15-25%, such as 17-23%.

The diluted pulp is thus dewatered on the forming wire and a paper web is formed. The diluted pulp typically has a pH of 5-6 and a consistency of 0.2-0.5%.

The method further comprises the step of:

e) pressing the paper web from step d) to a dry content of 30-50%, such as 36-46%.

The pressing section used for step e) typically has one, two or three press nips. In one embodiment, a shoe press is used. In such case, the nip of the shoe press can be the only nip of the pressing section. A benefit of using a shoe press is improved bending stiffness in the final product.

The method further comprises the step of:

0 drying the paper web from step e); and

g) compacting the paper web from step f) in a Clupak unit at a moisture content of 20-50%.

The compacting in the Clupak unit increases the stretchability of the paper, in particular in the MD, but also in the CD. To improve surface/printing properties, the moisture content of the paper is preferably at least ₃0% (e.g. 30-50%), such as at least 35% (e.g. 35-49%), when entering the Clupak unit. Higher moisture contents have also been shown to correlate with higher stretchabilities in the MD.

Further, the inventors have found that the increase in stretchability is facilitated by a relatively high nip bar line load, i.e. at least 20 kN/m, in the Clupak unit. Preferably, the nip bar line load is at least 2₅ kN/m or at least 28 kN/m. A typical upper limit may be 38 kN/m. In the Clupak unit, the nip bar line load is controlled by the adjustable hydraulic cylinder pressure exerted on the nip bar. The nip bar is sometimes referred to as the “nip roll”.

In one embodiment, the rubber belt tension in the Clupak unit is at least ₅ kN/m (such as 5-9 kN/m), preferably at least 6 kN/m (such as 6-9 kN/m), such as about 7 kN/m. In the Clupak unit, the rubber belt tension is controlled by the adjustable hydraulic cylinder pressure exerted on the tension roll stretching the rubber belt.

The Clupak unit typically comprises a steel cylinder or a chromed cylinder. When the paper web is compacted by the contraction/recoil of the rubber belt in the Clupak unit, it moves relative the steel/chromed cylinder. To reduce the friction between the paper web and the steel/chromed cylinder, it is preferred to add a release liquid. The release liquid may be water or water-based. The water-based release liquid may comprise a friction-reducing agent, such as polyethylene glycol or a silicone-based agent. In one embodiment, the release liquid is water comprising at least 0.5%, preferably at least 1%, such as 1-4%, polyethylene glycol.

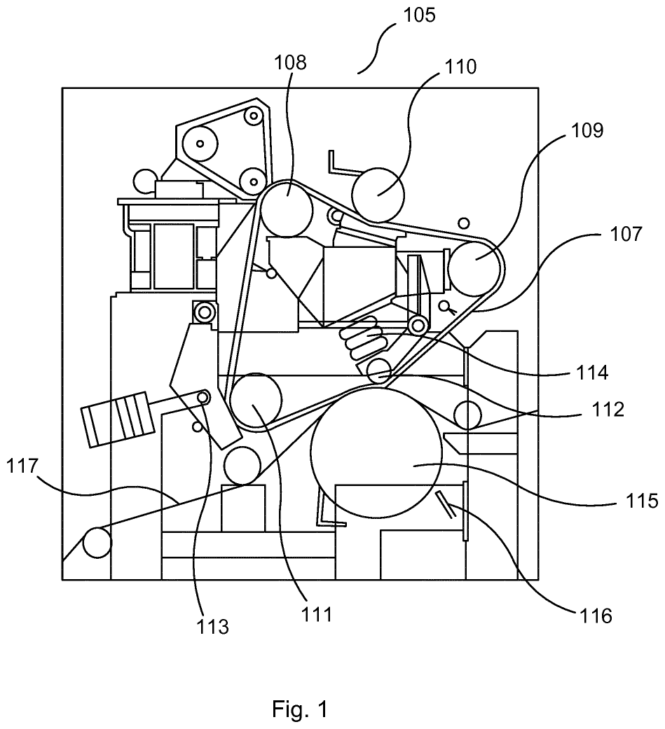

A Clupak unit is also described below with reference to FIG. 1.

After being compacted in the Clupak unit, the paper web is subjected to further drying. Consequently, the method further comprises the step of h) drying the paper web from step g).

Step h) thus comprises subjecting the paper web to drying in at least one dryer group. The speed of the paper web in the first dryer group of step h) is preferably 8-14% lower than the speed of the paper web entering the Clupak unit in step g). The reason for lowering the speed in this manner is to maintain the MD stretchability obtained by the paper web in the Clupak unit.

The paper web is preferably allowed to dry freely during part of step h). During such “free drying”, which improves the stretchability, the paper web is not in contact with a dryer screen (often referred to as a dryer fabric). A forced, optionally heated, air flow (sometimes referred to as “impingement drying”) may be used in the free drying, which means that the free drying may comprise fan drying.

The method further comprises the step of:

i) calendering the paper web from the drying step h) in a soft nip calender or a long nip calender at a moisture content of ₄-20%, preferably ₅-12%, such as 5-10%. The term “long nip calender” includes what is referred to in the art as shoe calenders, extended nip calenders and belt calenders.

In general, calendering improves surface properties. In the method of the present disclosure, a soft nip calender or a long nip calender is used as such calenders better preserves the bending resistance of the paper than hard nip calenders. When bending resistance is particularly important, the long nip calender is the most preferred option.

Independent of the type of calendar, the line load may be 20-700 kN/m. Preferred line load ranges are 20-450 kN/m and 100-400 kN/m. However, it may be preferred to keep the line load below 200 kN/m, such as below 150 kN/m, in step i) if a soft nip calender is used and bending resistance is considered.

The bending resistance index is obtained by dividing the bending resistance by the cube of the grammage. The bending resistance index in the MD of the paper is preferably at least 30 Nm⁶/kg³ (e.g. 30-43 Nm⁶/kg³), such as at least 35 Nm⁶/kg³ (e.g. 35-43 Nm⁶/kg³). Further, the bending resistance in the CD is preferably at least 40 Nm⁶/kg³ (e.g. 40-56 Nm⁶/kg³), such as at least 45 Nm⁶/kg³ (e.g. 45-56 Nm⁶/kg³). The bending resistance is measured according to ISO 2493 using a bending angle of 15° and a test span length of 10 mm.

In one embodiment, the bending resistance index is at least 39 Nm⁶/kg³ in the MD and at least 51 Nm⁶/kg³ in the CD. To obtain such bending resistance indexes, it is preferred to use a soft nip calender at a line load below 150 kN/m or a long nip calender. When a long nip calender is selected, it is possible to obtain a paper having a bending resistance index of at least 44 Nm⁶/kg³ (e.g. 44-56 Nm⁶/kg³) in the MD and at least 54 Nm⁶/kg³ (e.g. 54-62 Nm⁶/kg³) in the CD.

In one embodiment, the calendering of step i) is carried out using a long nip calender with a nip length in the machine direction of 30-400 mm, such as 30-250 mm. Further, a metal roll heated to a temperature between 140 and 260° C., preferably between 200 and 250° C., is used in the long nip calendering of step i).

In one embodiment, the nip length of the shoe calender is just 30-50 mm, while the temperature of the metal roll of the shoe calender is above 200° C. and the line load is at least 100 kN/m. Such an embodiment may efficiently reduce undesirable surface patterns formed in the Clupak unit.

The calendering reduces the surface roughness. Normally, the Bendtsen roughness of at least one side of the paper from step i) (i.e. the paper obtained by the method of the present disclosure) is 1900 ml/min or lower, such as 1700 ml/min or lower. Preferably, the Bendtsen roughness of the at least one side of the paper is 1200 ml/min or lower, such as 900 ml/min or lower. In one embodiment, it is 700 ml/min or lower, such as 600 ml/min or lower. A typical lower limit may be 300 ml/min or 400 ml/min. In a further embodiment, the Bendtsen roughness of both sides of the paper is below 1000 ml/min.

As understood by the skilled person, the above Bendtsen roughness values relate to uncoated paper.

In one embodiment, the method of the present disclosure further comprises the step of:

j) printing the paper from step i).

The printing of step j) may be on any side of the paper, but it may be preferred to print the side that contacts the steel/chromed cylinder in the

Clupak unit.

FIG. 1 illustrates a Clupak unit 105, comprising an endless rubber belt 107 (sometimes referred to as a “rubber blanket”) contacted by two blanket rolls 108, 109, a guide roll 110, a tension roll 111 and a nip bar 112. A first hydraulic arrangement 113 exerts pressure on the tension roll 111 to stretch the rubber belt 107. A second hydraulic arrangement 114 exerts pressure on the nip bar 112 to press the rubber belt 107, which in turns presses the paper web 117 against a steel cylinder 115. A release liquid spray nozzle 116 is arranged to apply a release liquid to the steel cylinder 115.

### EXAMPLES

Full-scale trials were carried out to produce white stretchable paper on a paper machine normally used for producing sack paper. Both calendered (inventive) paper and non-calendered (reference) paper was produced.

The production is described below.

A bleached softwood sulphate pulp was provided. The pulp was subjected to high consistency (HC) refining (180 kWh per ton paper) at a consistency of about 39% and low consistency (LC) refining (65 kWh per ton paper) at a consistency of about 4.3%. Cationic starch (7 kg per ton paper), rosin size (2.4 kg per ton paper) and alum (3.5 kg per ton paper) were added to the pulp. In the headbox, the pH of the pulp/furnish was about 5.8 and the consistency of the pulp/furnish was about 0.3%. A paper web was formed on a wire section. The dry content of the paper web leaving the wire section was about 19%. The paper web was dewatered in a press section having two nips to obtain a dry content of about 38%. The dewatered paper web was then dried in a subsequent drying section having nine dryer groups, including one Clupak unit, arranged in series. In this context, the Clupak unit was thus considered to be a “dryer group”. The Clupak unit was arranged as dryer group seven, which means that the paper web was dried in the drying section both before and after being compacted in the Clupak unit. When entering the

Clupak unit, the moisture content of the paper web was 40%. The hydraulic cylinder pressure exerted on the nip bar was set to 30 bar, resulting in a line load of 33 kN/m. The hydraulic cylinder pressure stretching the rubber belt was set to 31 bar, resulting in a belt tension of 7 kN/m. To reduce the friction between the paper web and the steel cylinder in the Clupak unit, a release liquid (1.5% polyetylene glycol) was added in an amount of 250 litre/hour. The speed of the paper web in the dryer group directly downstream the Clupak was 11% lower than the speed of the paper web entering the Clupak unit

Subsequent to the drying in the drying section, the inventive paper was subjected to calendering in a soft nip calender having a hard roll (steel surface) and a soft roll (surface covered with rubber). The line load in the soft nip calender was 145 kN/m. The temperature and moisture content of the paper entering the soft nip calender was 80° C. and 6.5%, respectively. The reference paper was not calendered.

The properties of the papers produced in the trials are presented in table 1 below.

TABLE 1
Paper properties of the calendered (inventive) paper and the
non-calendered (reference) paper. The properties “Printing
density” and uncovered area (“UCA”) were measured
after the papers had been printed. Regarding “Printing density”, a
higher number is better. Regarding UCA, a lower number is better.

| | Calendered | Non-calendered |
|---|---|---|
| Trial | (inventive) paper | (reference) paper |
| Grammage (g/m²) | 150 | 150 |
| Thickness (μm) | 157 | 195 |
| Density (kg/m³) | 956 | 764 |
| Tensile strength, MD (kN/m) | 12.5 | 12.4 |
| Tensile strength, CD (kN/m) | 7.3 | 6.9 |
| Tensile index, MD (kNm/kg) | 83 | 83 |
| Tensile index, CD (kNm/kg) | 49 | 46 |
| Stretchability, MD (%) | 14.0 | 14.4 |
| Stretchability, CD (%) | 9.6 | 9.9 |
| TEA, MD (J/m²) | 991 | 1010 |
| TEA, CD T (J/m²) | 481 | 479 |
| TEA index, MD (J/g) | 6.6 | 6.8 |
| TEA index, CD (J/g) | 3.2 | 3.2 |
| Burst strength (kPa) | 777 | 775 |
| Burst index (mN/kg) | 5.2 | 5.2 |
| Bending resistance, MD (mN) | 132 | 170 |
| Bending resistance, CD (mN) | 174 | 194 |
| Bending resistance index, MD | 39.1 | 50.4 |
| (Nm⁶/kg³) | | |
| Bending resistance index, CD | 51.6 | 57.5 |
| (Nm⁶/kg³) | | |
| Gurley value (s) | 103 | 38 |
| Brightness (%) | 83 | 83 |
| Bendtsen roughness, SS* | 460 | 1596 |
| (ml/min) | | |
| Bendtsen roughness, RS** | 665 | 3246 |
| (ml/min) | | |
| Printing density, SS* | | 1.56 |
| Printing density, RS** | 1.62 | 1.48 |
| UCA (%), SS* | ~0.018 | |
| UCA (%), RS** | 0 | 0.147 |

*Steel side in calender, rubber side in Clupak
**Rubber side in calender, steel side in Clupak

As shown in table 1, highly stretchable uncoated white paper having a high Gurley value (i.e. low porosity) was obtained. Table 1 further shows that the soft nip calendering significantly improved surface and printing properties, in particular of the side of the paper contacting the (soft) rubber-covered roll. However, the soft nip calendering decreased the bending resistance, which is sometimes undesired. The decrease in bending resistance can be at least partly avoided by using a long nip calender instead of the soft nip calender.

Further, the visual impression of the quality of the print on the steel side (SS) and the rubber side (RS) of the calendered (inventive) paper was compared to that of the non-calendered (reference) paper. The same type of comparison was also made after the papers had been subjected to ₃D-forming. According to the comparison, the print quality was significantly better on both sides of the calendered (inventive) paper than on the reference paper before and after ₃D-forming. The comparison also showed that the print quality was better on the side that contacted the steel cylinder in the Clupak unit.

1. Method of producing uncoated paper having a grammage according to ISO 536 of 50-250 g/m², a Gurley value according to ISO 5636-5 of above 15 s and a stretchability according to ISO 1924-3 in the machine direction of at least 9%, said method comprising the steps of:
a) providing a pulp, preferably sulphate pulp;
b) subjecting the pulp to high consistency (HC) refining;
c) subjecting the pulp from step b) to low consistency (LC) refining;
d) diluting the pulp from step c) and adding the diluted pulp to a forming wire to obtain a paper web having a dry content of 15-25%;
e) pressing the paper web from step d) to a dry content of 30-50%;
f) drying the paper web from step e);
g) compacting the paper web from step f) in a Clupak unit at a moisture content of 20-50%;
h) drying the paper web from step g); and
i) calendering the paper web from step h) in a soft nip calender or a long nip calender at a moisture content of 4-20%.

2. The method of claim 1, further comprising the step of adding broke pulp to the pulp from step b) or c).

3. The method of claim 1, wherein the calendering of step i) is carried out using a shoe calender with a nip length in the machine direction of 30-400 mm.

4. The method of claim 3, wherein the line load in step i) is 20-700 kN/m.

5. The method of claim 3, wherein a metal roll heated to a temperature between 140 and 260° C. is used in the shoe calendering of step i).

6. The method of claim 1, wherein the stretchability according to ISO 1924-3 in the machine direction is at least 10%.

7. The method of claim 1, wherein the stretchability according to ISO 1924-3 in the cross direction is at least 7%.

8. The method of claim 1, wherein the grammage according to ISO 536 of the paper is 80-200 g/m².

9. The method of claim 1, wherein the Gurley value according to ISO 5636-5 of the paper is at least 20 s.

10. The method of claim 1, wherein the Bendtsen roughness according to ISO 8791-2 of at least one side of the paper is 1700 ml/min or lower.

11. The method of claim 1, wherein the bending resistance index according to ISO 2493 in the machine direction of the paper is at least 30 Nm⁶/kg³, and wherein the bending resistance is tested using a bending angle of 15° and a test span length of 10 mm

12. The method of claim 1, wherein the bending resistance index according to ISO 2493 in the cross direction of the paper is at least 40 Nm⁶/kg³, and wherein the bending resistance is tested using a bending angle of 15° and a test span length of 10 mm.

13. The method of claim 1, wherein the brightness of the paper according to ISO 2470 is at least 80%.

14. The method of claim 1, further comprising the step j) printing the side of the paper that contacted the steel/chromed cylinder in the Clupak unit.

15. The method of claim 1. wherein step h) comprises subjecting the paper web to drying in at least one dryer group and wherein the speed of the paper web in the first dryer group of step h) is 8-14% lower than the speed of the paper web entering the Clupak unit in step g).

16. The method of claim 1, wherein:
the consistency of the pulp subjected to HC refining in step b) is 25-42%;
the HC refining of step b) is carried out to the extent that the pulp obtains a Schopper-Riegler (SR) number according to ISO 5267-1 of 13-19;
the consistency of the pulp subjected to LC refining in step c) is 2-6%; and
the LC refining of step c) is carried out to the extent that the pulp obtains a Schopper-Riegler (SR) number according to ISO 5267-1 of 18-40.

17. The method of claim 1, wherein the paper web from step f) is compacted in the Clupak unit of step g) at a moisture content of 30-49%.

18. The method of claim 17, wherein the paper web from step f) is compacted in the Clupak unit of step g) at a moisture content of 35-49%.

19. The method of claim 1, wherein the paper web from step h) is calendered in step i) a moisture content of 5-12%.

20. The method of claim 4, wherein the line load in step i) is 20-450 kN/m.

21. The method of claim 20, wherein the line load in step i) is 100-400 kN/m.

22. The method of claim 6, wherein the stretchability according to ISO 1924-3 in the machine direction is at least 11%.

23. The method of claim 7, wherein the stretchability according to ISO 1924-3 in the cross direction is at least 9%.

24. The method of claim 8, wherein the grammage according to ISO 536 of the paper is 80-160 g/m².

25. The method of claim 10, wherein the Bendtsen roughness according to ISO 8791-2 of at least one side of the paper is 900 ml/min or lower.
